(19) United States
(12) Patent Application Publication
(10) Pub. No.: US 2002/0125736 A1
(43) Pub. Date: Sep. 12, 2002

(54) Seating, handrails & canopy for rooftop deck vehicles

(76) Inventor: Frank Messano, Simi Valley, CA (US)

Correspondence Address: Frank Messano, 2100 Heyneman Lane, Simi Valley, CA, 93065, US

(21) Appl. No.: 10/142,403

(22) Filed: May 10, 2002

Related U.S. Application Data
(63) Continuation-in-part of application No. 09/766,996, filed on Jan. 23, 2001.
Application No. 09/766,996 is a continuation-in-part of application No. 09/491,764, filed on Jan. 27, 2000, now Pat. No. 6,237,988.

(51) Int. Cl. B60P 3/34

(52) U.S. Cl. 296/165

(57) ABSTRACT

A vehicle rooftop deck system of affixed seating, handrails, and deck canopy-roof which raise for rooftop occupancy and lower for travel on recreational vehicles, amphibious vehicles, and watercraft.

### CROSS-REFERENCE TO RELATED APPLICATIONS

This invention relates to my previous U.S. Pat. No. 6,237,988—STREAMLINE ROOFTOP DECK FOR MOTORHOMES and my allowed application Ser. No. 09/766,966—ROOFTOP DECK SYSTEMS FOR VEHICLES which included claims for a raising & lowering convertible top, and claims for raising & lowering safety handrails, and claims for raising & lowering seating atop a vehicle uppermost rooftop deck, where this new invention is an enhancement of those inventions with a vertical raising rooftop deck cover-canopy and auto-raising handrails and folding rooftop seating.

### BACKGROUND OF THE INVENTION

1. Field of the Invention

This invention relates generally to permanently mounted streamline folding rooftop deck assemblies for vehicles as described in U.S. Pat. No. 6,237,988—STREAMLINE ROOFTOP DECK FOR MOTORHOMES which claims . . .

A vehicle rooftop deck system comprising:

a plurality of streamline cowlings enclosing the perimeter of a vehicle rooftop;

a plurality of rooftop safety handrails which fold down to a low profile for travel, which fold upward for use, which enclose the perimeter of the rooftop when in the upward position, and which affix to the rooftop;

folding rooftop furniture, backs of which support the safety handrails, and which backs fold down to a low profile for travel and which backs fold upward for use, and furniture under structure which affixes the furniture to the rooftop and which affixes the streamline cowlings to the vehicle rooftop.

And its additional claims . . .

wherein the vehicle is a motorhome.

wherein the vehicle is a travel trailer.

a retractable stair hatchway with a retractable stairway.

a retractable stairway safety handrail.

a hatch lid that raises a portion of the safety handrail to an upward position.

a seamless rooftop deck formed of a fiber and resin composite.

a stairway affixed to the back of the vehicle folding flat against the back for travel.

a folding barbecue console, and a folding food & drink console, and a sofa-bed.

an exterior stairway.

an interior stairway or ladder or elevator through a rooftop hatchway.

a raising and lowering convertible top unit fixed in place within the deck.

a rooftop bathing unit.

an intermediate deck level (split-level floors) within the interior of the vehicle.

And invention application Ser. No. 09/766,966—ROOFTOP DECK SYSTEMS FOR VEHICLES which claims . . .

A vehicle rooftop deck system comprising:

a cowling enclosing the perimeter of a vehicle rooftop;

a plurality of rooftop safety handrails which fold down to a low profile for travel, which fold upward for use, which enclose the perimeter of the rooftop when in the upward position;

folding rooftop furniture which backs fold down to a low profile for travel and which backs fold upward for use.

And its additional claims . . .

wherein the cowling is one-piece.

wherein the cowling and furniture understructure are one-piece.

wherein the cowling, furniture understructure and a rooftop deck are one-piece.

wherein the one-piece cowling, furniture understructure and deck assembly form the roof of the vehicle.

wherein the cowling and deck are one-piece.

wherein a number of sub-assemblies form a one-piece molded roof-deck structure.

wherein a number of sub-assemblies form a one-piece monocoque roof-deck structure,

wherein the system is also comprised of the vehicle roof with a hatchway through the roof to the interior of the vehicle.

wherein the vehicle is a motorhome.

wherein the vehicle is a trailer.

wherein the vehicle is amphibious.

wherein the furniture folding backs support the safety handrails.

wherein the cowling encloses only a portion of the perimeter of a vehicle roof.

wherein the safety handrails only enclose a portion of the perimeter of a vehicle roof.

My new invention of a vertical raising & lowering cover-canopy above the uppermost rooftop deck of a vehicle and of automatic raising & lowering handrails upon the uppermost rooftop deck of a vehicle incorporates some elements of my aforementioned inventions.

2. Description of Related Art

It is known in the art of convertible roofs on automobiles, where solid or fabric roofs retract downward or slide open sideways to expose the occupants to the weather elements. See, for example, U.S. Pat. No. 6,345,860 (Adam 2002), U.S. Pat. No. 6,347,827 (Maass 2002), and U.S. Pat. No. 6,347,828 B1 (Rapin 2002). While convertible roofs are common for automobiles, it is not known in the art of a two-story vehicle, more specifically a one-story recreational vehicle with a second-story open deck having a retracting structure around the upper story (Messano's inventions U.S. Pat. No. 6,237,988—STREAMLINE ROOFTOP DECK FOR MOTORHOMES and allowed application Ser. No. 09/766,966—ROOFTOP DECK SYSTEMS FOR VEHICLES), that incorporates a vertical raising cover to protect the rooftop furnishings in the lowered position, and is a canopy for shelter from the weather elements in the raised position for the occupants of the uppermost open rooftop deck.

And it is known in the art for camper vans (trucks) to have raising roofs to increase the headroom space of the vehicle to allow for a person to comfortably stand; for example U.S. Pat. No. 4,262,956 (Kellam 1981) and U.S. Pat. No. 6,325,447 B1 (Kuo 2001) to name but just a few. While raising roofs are common for camper vans, it is not known in the art of a two-story vehicle, more specifically a one-story recreational vehicle with a second-story open deck having a retracting structure around the upper story (Messano's inventions U.S. Pat. No. 6,237,988—STREAMLINE ROOFTOP DECK FOR MOTORHOMES and allowed application Ser. No. 09/766,966 ROOFTOP DECK SYSTEMS FOR VEHICLES), that incorporates a vertical raising cover to protect the rooftop furnishings in the lowered position, and is a canopy for shelter from the weather elements in the raised position for the occupants of the uppermost open rooftop deck.

And it is known in the art for trucks and cargo trailers to have raising covers to increase cargo space of the vehicle; for example U.S. Pat. No. 5,016,858 (Kellam 1981), U.S. Pat. No. 5,366,266 (Harbison 1994), and U.S. Pat. No. 6,086,134 (Cravens 2000), to name but just a few. While raising cargo covers are common for trucks and cargo trailers, it is not known in the art of a two-story vehicle, more specifically a one-story recreational vehicle with a second-story open deck having a retracting structure around the upper story (Messano's inventions U.S. Pat. No. 6,237,988—STREAMLINE ROOFTOP DECK FOR MOTORHOMES and allowed application Ser. No. 09/766,966—ROOFTOP DECK SYSTEMS FOR VEHICLES), that incorporates a vertical raising cover to protect the rooftop furnishings in the lowered position, and is a canopy for shelter from the weather elements in the raised position for the occupants of the uppermost open rooftop deck.

And it is known in the art for recreational vehicles to have two enclosed stories and for recreational vehicles to have an un-covered uppermost rooftop deck; for example U.S. Pat. No. 5,374,094 (Smith 1994), U.S. Pat. No. 5,967,583 (Wishart 1999), and U.S. Pat. No. 6,302,475 B1 (Anderson 2001), to name but just a few. But it is not known in the art any claims where a two-story vehicle, more specifically a one-story recreational vehicle with a second-story open deck having a retracting structure around the upper story (Messano's inventions U.S. Pat. No. 6,237,988 STREAMLINE ROOFTOP DECK FOR MOTORHOMES and allowed application Ser. No. 09/766,966—ROOFTOP DECK SYSTEMS FOR VEHICLES), that incorporates a vertical raising cover on the upmost roof to protect the rooftop furnishings in the lowered position, and is a canopy for shelter from the weather elements in the raised position for the occupants of the uppermost open rooftop deck.

And it is known in the art for recreational vehicles to have collapsible safety handrails upon the rooftop deck; for example U.S. Pat. No. 3,050,330 (Willson 1962), U.S. Pat. No. 3,608,964 (Lynd 1971), and U.S. Pat. No. 5,967,583 (Wishart 1999), to name but just a few. But it is not known in the art any claims where a two-story vehicle, more specifically a one-story recreational vehicle with a second-story open deck having a retracting structure around the upper story (Messano's inventions U.S. Pat. No. 6,237,988—STREAMLINE ROOFTOP DECK FOR MOTORHOMES and allowed application Ser. No. 09/766,966—ROOFTOP DECK SYSTEMS FOR VEHICLES), that incorporates motor actuated raising & lowering safety handrails atop the uppermost rooftop deck of a vehicle.

Since therefore my U.S. Pat. No. 6,237,988—STREAMLINE ROOFTOP DECK FOR MOTORHOMES is the only previous claim of a raising & lowering convertible top unit, and claims raising & lowering safety handrails for the uppermost rooftop deck of a vehicle, this invention of an automatic raising cover-canopy, and motor actuated raising & lowering safety handrails upon the uppermost open deck of a vehicle is an enhancement of my previous patents.

### SUMMARY OF THE INVENTION

A vehicle rooftop deck system of affixed seating, handrails, and deck canopy-roof which raise for rooftop occupancy and lower for travel on recreational vehicles, amphibious vehicles, and watercraft.

### BRIEF DESCRIPTION OF THE DRAWINGS

Other features and advantages of the present invention will be apparent from the following detailed descriptions of preferred embodiments thereof when read in conjunction with reference to the accompanying drawings, wherein:

FIG. 1 is a perspective view of one embodiment of the invention depicting a representative vertical raising & lowering cover-canopy (in solid line) in the lowered position on a typical recreational vehicle rooftop deck system (motorhome shown in broken lines).

FIG. 2 is a perspective view of the same raising & lowering cover-canopy of FIG. 1 (in solid line) shown with the cover-canopy in the raised position on a typical recreational vehicle rooftop deck system (shown in broken line) and showing an embodiment of the safety handrails from Messano U.S. Pat. No. 6,237,988 & patent application Ser. No. 09/766,966 in the raised position (shown in broken line).

FIG. 3 is a perspective view of the same raising & lowering cover-canopy of FIG. 2 showing one embodiment of a concealed raising & lowering system with the cover-canopy in the raised position (in solid line) on a typical recreational vehicle rooftop deck system (shown in broken line).

FIG. 4 is a cross-section through the typical vehicle and through the cover-canopy with the concealed raising & lowering system shown within the sidewalls of the vehicle, showing the cover-canopy in the lowered position.

FIG. 5 is the same cross-section as FIG. 4 through the typical vehicle and through the cover-canopy with the concealed raising & lowering system shown within the sidewalls of the vehicle, but showing the cover-canopy in the raised position.

FIG. 6 is the same cross-section as FIG. 5 through the typical vehicle and through the cover-canopy with the concealed raising & lowering system shown within the sidewalls of the vehicle, showing the cover-canopy in the raised position, but also showing an embodiment of the safety handrails from Messano U.S. Pat. No. 6,237,988 & patent application Ser. No. 09/766,966 in the raised position.

FIG. 7 is a perspective view of one embodiment of the invention depicting the representative raising & lowering safety handrails (in solid line) in the lowered position on a typical recreational vehicle rooftop deck system (vehicle shown in broken lines). The cover-canopy is not shown for clarity.

FIG. 8 is a cross-section through the raising & lowering safety handrails and through the vehicle roof, showing the handrails in the lowered position.

FIG. 9 is the same perspective view of FIG. 7, showing the handrails in the raised position.

FIG. 10 is the same cross-section as FIG. 8, showing the handrails in the raised position.

FIG. 11 is a cross-section through the raising & lowering safety handrails and through the vehicle roof, showing the combined handrails & seating in the raised position.

FIG. 12 is the same cross-section as FIG. 11, showing the handrails & seating in the lowered position.

### DETAILED DESCRIPTION OF THE PREFERRED EMBODIMENTS

In my previous U.S. Pat. No. 6,237,988 (Messano)—STREAMLINE ROOFTOP DECK FOR MOTORHOMES, and allowed application Ser. No. 09/766,966—ROOFTOP DECK SYSTEMS FOR VEHICLES included claims for a raising & lowering convertible top and claims for raising & lowering safety handrails atop a vehicle uppermost rooftop deck and claims for rooftop affixed raising & lowering furniture, where this new invention is an enhancement of those inventions with a vertical raising deck cover-canopy, and auto-raising handrails.

In this invention, the drawings depict the rooftop system of my previous inventions for reference, and show embodiments of this new invention applied to those previous inventions. This new invention is not limited to application in part or whole with my previous inventions, but is shown in this context for clarity of the reader. The number and kind of elements depicted, their lengths and widths, and their locations vary depending upon the physical conditions of the vehicle to which they are affixed. The preferred embodiments are not limiting, but illustrate typical types of applications.

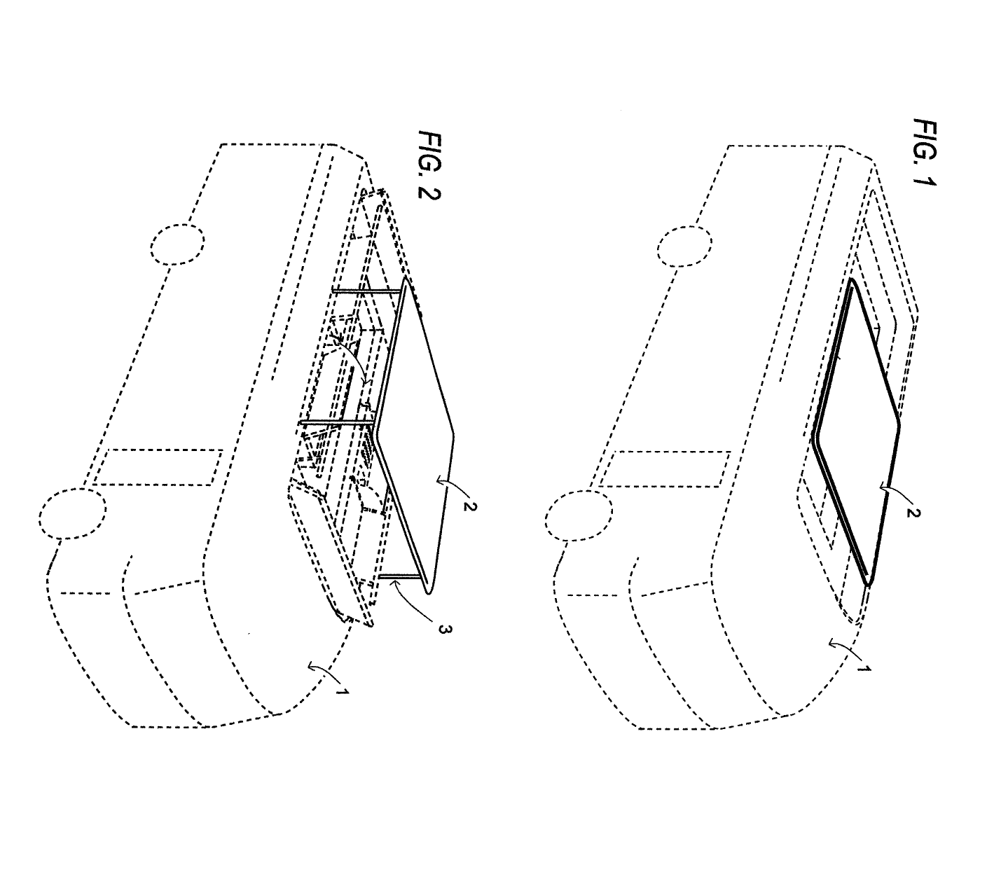

With reference to FIG. 1, a perspective view of one embodiment of the invention depicting a typical recreational vehicle with included rooftop deck system (motorhome-deck system shown in broken lines) 1, shows a cover-canopy (above deck raising & lowering roof shown in solid line) in the lowered position 2 for travel or storage. While the cover-canopy is shown partially covering the vehicle rooftop deck for illustration purposes in this embodiment, the cover-canopy may be of any size, and may cover the entire perimeter of the vehicle. And while the illustration depicts a motorhome, the scope of the invention includes all land and water vehicles (water craft), and amphibious vehicles.

FIG. 2 is a perspective view of the same raising & lowering cover-canopy of FIG. 1 (in solid line) shown with the cover-canopy 2 in the raised position on a typical vehicle rooftop deck system 1. In the raised position of this embodiment, a cover-canopy support 3 is shown at the corners of the cover-canopy for illustrative purposes. The number of supports 3 is not limited to four supports, as any number or types of supports may be used within the scope of this invention.

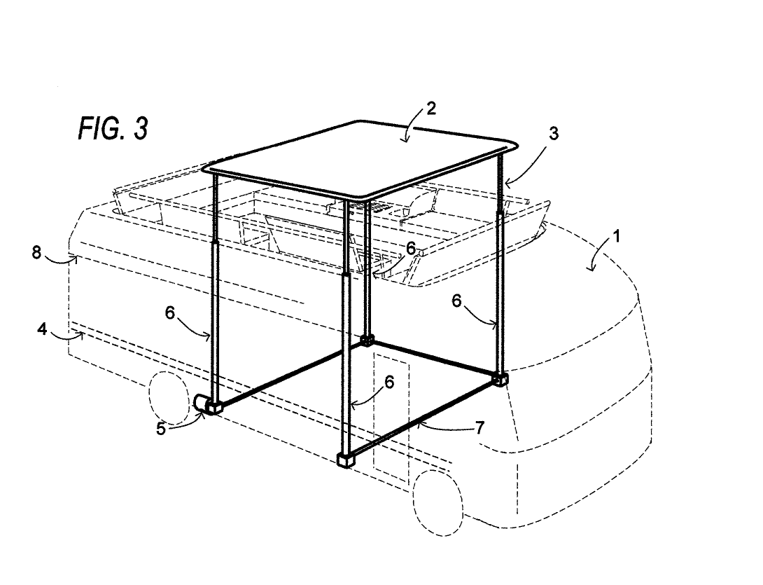

FIG. 3 is a perspective view of the same raising & lowering cover-canopy 2 of FIG. 2 (in solid line) shown with the cover-canopy 2 in the raised position on a typical vehicle rooftop deck system 1. Also shown in this embodiment of the raising system, are the cover-canopy supports 3 telescoping within a weather outer support tube 6 running through the vehicle rooftop deck 8 and the vehicle interior floor 4, where, under the vehicle, is located one embodiment of the cover-canopy (roof) raising and lowering drive system. This embodiment of the drive system consists of a reversible rotating actuator, motor or pump (5), a concealed revolving vertical column screw 12 (shown in FIG. 6 detail drawing) within the weather outer support tube 6 and the cover-canopy support 3 set, which raises and lowers the cover-canopy supports 3. Also shown is a connection 7 between a number (not necessarily all) of the raising supports to coordinate their raising and descending in unison. The connection may be mechanical (as depicted in this embodiment) or a tube for fluids or air, or a cable for electrical connection, or any other suitable means. While any motor-actuator-pump type (rotating, linear, fluid, air, cylinder, or any other suitable motion device) of motive system is within the scope of this invention, this embodiment illustrates a rotating motor 5, turning a concealed revolving vertical column screw 12 (shown in FIG. 6 detail drawing) which raises and lowers a concealed threaded (meshed) element 14 within the cover-canopy support 3 (shown in FIG. 6 detail drawing). Also shown is the connection 7 to three other weather outer support tubes 6, which said connector, in this embodiment, is a horizontal rotating shaft 7 to turn the concealed vertical column screws 12 (within weather outer support tubes 6) in unison, thus raising and lowering the cover-canopy roof. In other embodiments, the raising and lowering of the cover-canopy roof may utilize hydraulic or air cylinders, cables, push-pull links, linear actuators, or any other system to raise or lower the cover-canopy roof, all of which motive systems are within the scope of this invention.

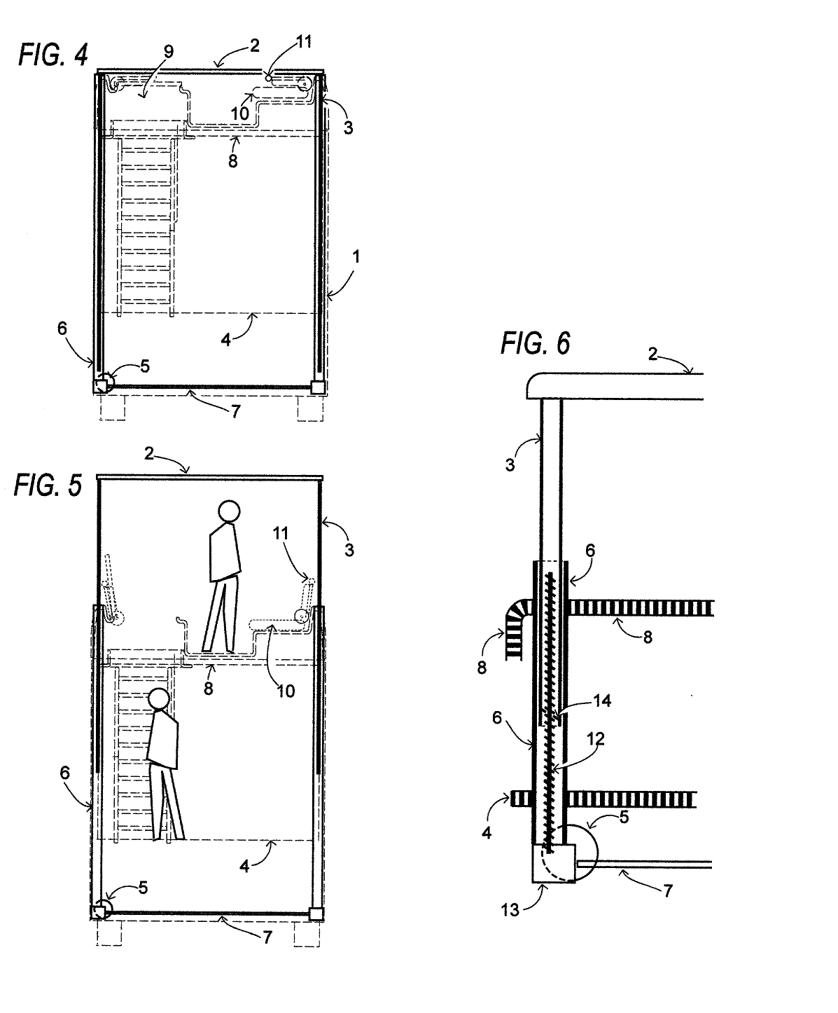

FIG. 4 is a center cross-section of FIG. 1 on a plane through the vehicle 1 (in broken line), through the vehicle rooftop deck 8 (in broken line), through the vehicle floor 4 (in broken line), through the cover-canopy 2 (in solid line), through the cover-canopy raising supports 3 (in wide-width solid line), through the weather outer support tubes 6, and through the horizontal rotating shaft (7) connecting the weather outer support tubes 6. In this lowered position, the cover-canopy 2 protects the deck 8 and hatchway 9 and rooftop furnishings 10 and retracted handrails 11 (Messano U.S. Pat. No. 6,237,988) from weather elements and road dirt.

FIG. 5 is the same cross-section of FIG. 4, showing the cover-canopy 2 (solid line) in the raised position for occupancy, and showing the cover-canopy raising supports 3 (in wide-width solid line) in the raised position within the weather outer support tubes 6 and showing the open hatchway 9, open rooftop furnishings 10, and the open handrails 11 (in broken line).

FIG. 6 is larger detail view of FIG. 5 showing the edge section of the cover-canopy 2, and related sections of the cover-canopy raising support 3, a revolving vertical column screw 12, and the weather outer support tube 6 running through the vehicle rooftop deck 8 and the vehicle interior floor 4. In operation, a gear 13 on the motor 5 turns the revolving vertical column screw 12. A screw interface 14 affixed within the cover-canopy raising support 3 causes the cover-canopy raising support 3 to ride up and down the screw 12, depending upon the rotation direction of the screw . . . which in turn raises (or, in reverse lowers) the cover-canopy roof 2. The cover-canopy raising support 3 additionally slides within the weather outer support tube 6. The weather outer support tube 6 protrudes above the rooftop deck surface 8, with the tube's outer surface sealed to the roof surface to prevent water and air from leaking into the interior of the vehicle. Similarly, the weather outer support tube 6 is sealed where it exits the vehicle floor 4 to prevent water, exhaust, and air from entering the interior space of the vehicle. Water and air flowing down through the center of the weather outer support tube 6 drains below the vehicle.

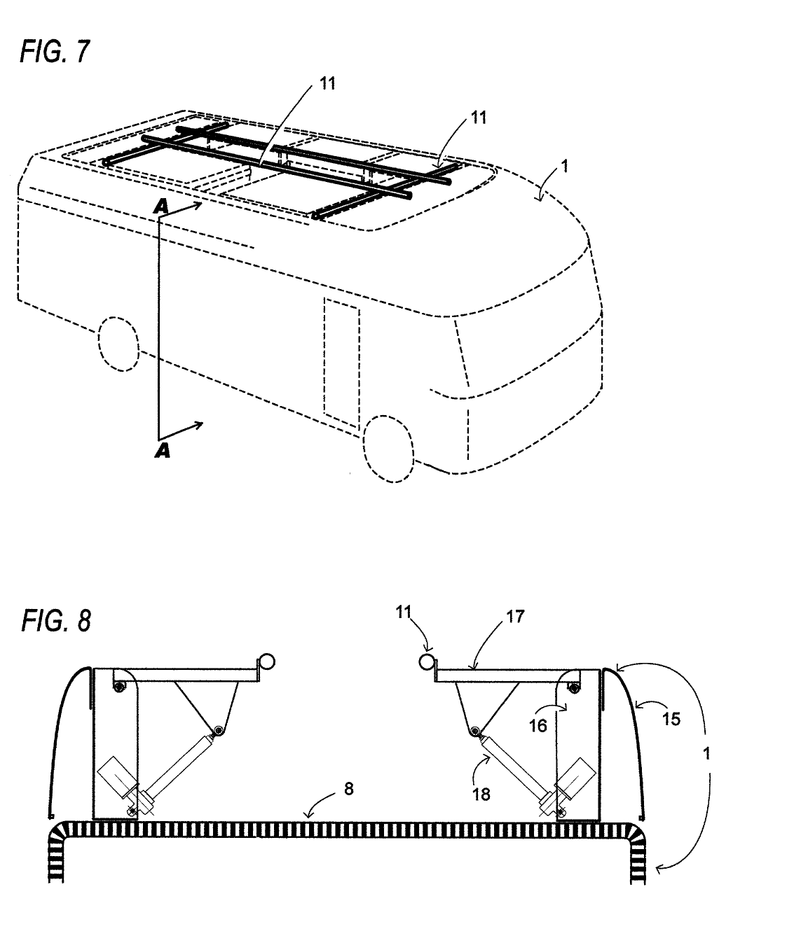

FIG. 7 is the same perspective view as FIG. 1 of the typical vehicle rooftop deck system 1 (in broken line), but without the cover-canopy, showing the safety handrails 11 in the lowered position for travel.

FIG. 8 is a center cross-section A-A of FIG. 7 at a plane through the vehicle rooftop deck 8 (in heavy broken line), through the rooftop cowling 15 of Messano U.S. Pat. No. 6,237,988 (in broken line), through handrail stanchion base 16, through handrail stanchion 17, through handrail 11, and through actuator 18 (all in solid line). The handrail 11 and stanchion 17 are shown in the lowered position for travel.

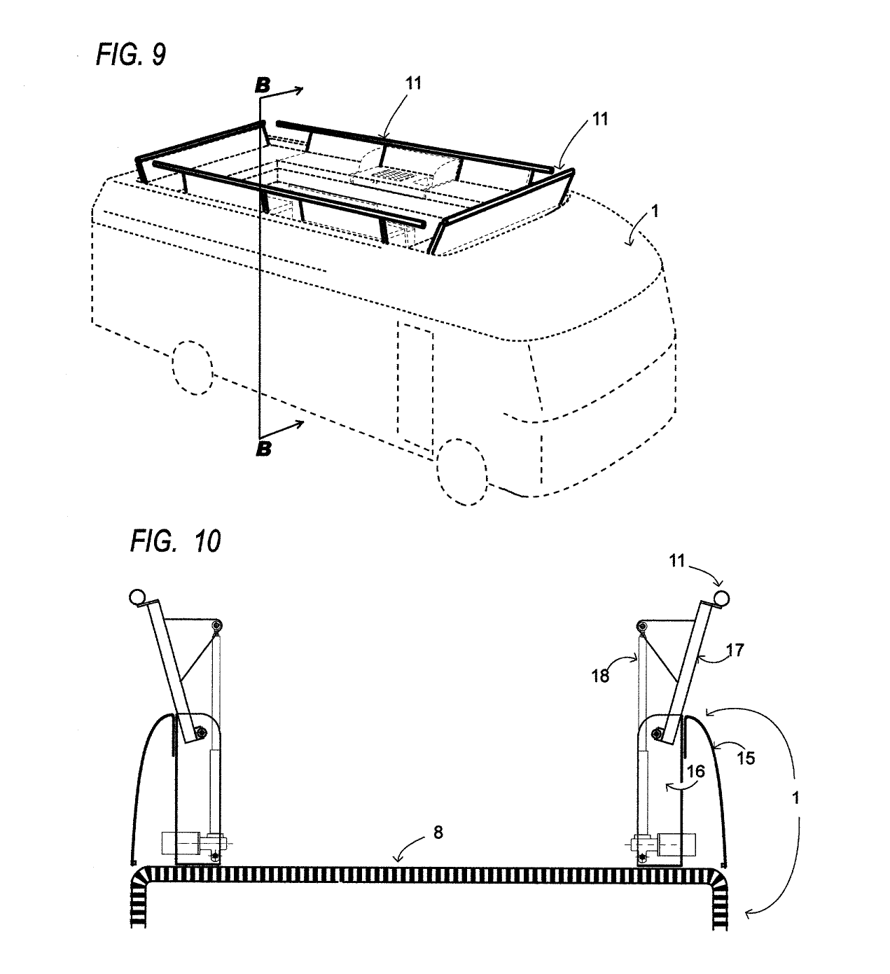

FIG. 9 is the same perspective view as FIG. 7 of the typical vehicle rooftop deck system 1 without the cover-canopy (in broken line), showing the safety handrails 11 in the raised position for use.

FIG. 10 is a center cross-section B-B of FIG. 9 at a plane through the vehicle rooftop deck 8 (in heavy broken line), through the rooftop cowling 15 of Messano U.S. Pat. No. 6,237,988 (in broken line), through handrail stanchion base 16, through handrail stanchion 17, through handrail 11, and through actuator 18 (all in solid line). The handrail 11 and stanchion 17 are shown in the raised position for use. In operation (within this particular embodiment of the invention), one end of the motor driven linear actuator 18 is connected to the stanchion base 16 and the other end of the actuator 18 is connected to the handrail stanchion 17, whereby retracting the linear actuator 18 lowers the handrail 11, and extending the linear actuator 18 raises the handrail 11.

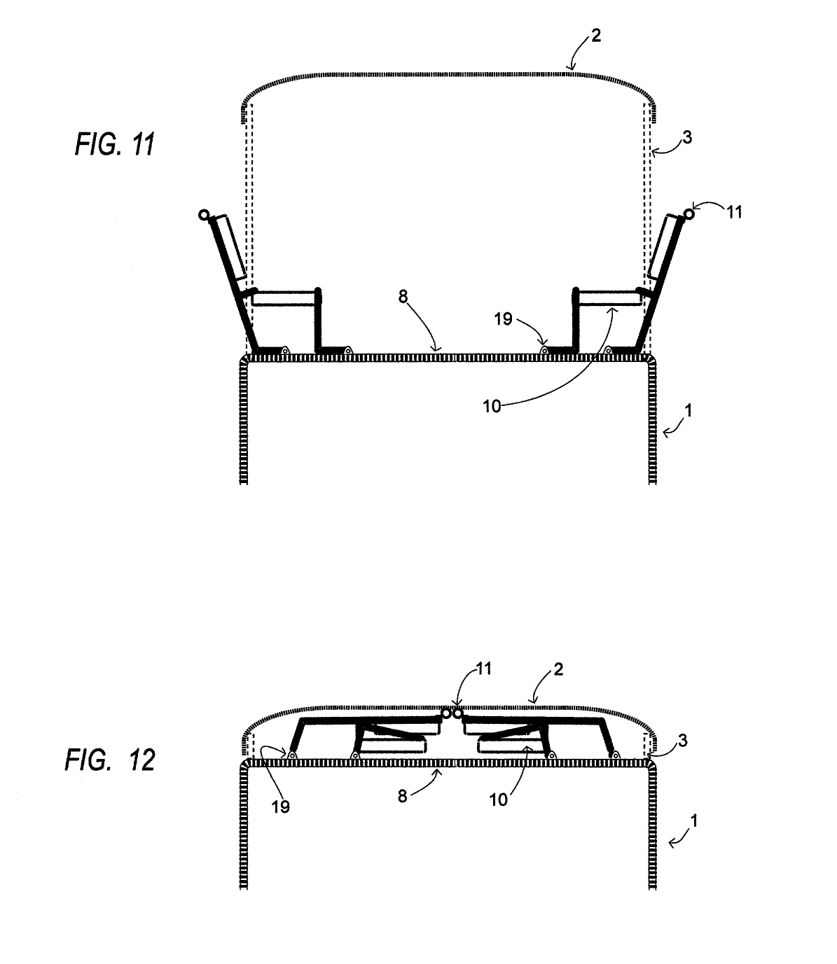

FIG. 11 is a cross-section similar to FIG. 10 of a typical vehicle rooftop deck 8 (in heavy broken line) showing the cover-canopy 2 and raising supports 3 in the raised position for use. This embodiment shows the rooftop seat 10 and handrail 11 in the raised position for use. The seat bases are hinged 19 to the rooftop deck.

FIG. 12 is the same cross-section as FIG. 11 of the typical vehicle rooftop deck 8 (in heavy broken line) showing the cover-canopy 2 and raising supports 3 in the lowered position for travel. In this lowered position, the deck hinged seats 10 and safety handrails 11 are folded down. Also, in this embodiment, the cover-canopy 2 substantially covers the seating as protection against the elements.

While this present invention herein relates to my previous U.S. Pat. No. 6,237,988 (Messano)—(STREAMLINE ROOFTOP DECK FOR MOTORHOMES) and my allowed application Ser. No. 09/766,966—ROOFTOP DECK SYSTEMS FOR VEHICLES which included claims for a raising & lowering convertible top, and claims for raising & lowering safety handrails, and claims for raising & lowering seating atop a vehicle uppermost rooftop deck, where this new invention is an enhancement of those inventions with a vertical raising rooftop deck cover-canopy and auto-raising handrails and folding rooftop seating, this new invention has been described with respect to the preferred embodiments thereof, and it is to be understood that the invention is not limited to such precise forms of the apparatus, nor limited in application to my previous patents, and that some or any combination of the elements may be used, and that changes may be made therein on any vehicle without departing from the scope of the invention defined in the appended claims.

What is claimed:

1. A vehicle rooftop deck system comprising:
a raising and lowering roof-cover atop a vehicle exterior rooftop deck;
a rigid uppermost surface of said roof-cover;
a plurality of rooftop elements supporting said roof-cover;
a drive linkage connected to said elements for raising and lowering them in unison;
a powered actuator to raise and lower said supporting elements;
a waterproof vertical raceway locating said actuator system below the rooftop deck;
a plurality of rooftop affixed safety handrails which raise and lower under said roof-cover;
and a plurality of rooftop affixed seating which raise and lower under said roof-cover.

2. The rooftop deck system of claim 1, wherein the roof-cover is a fabric.

3. The rooftop deck system of claim 1, without a powered drive linkage.

4. The rooftop deck system of claim 1, without locating the actuator system below the rooftop.

5. The rooftop deck system of claim 1, without the safety handrails.

6. The rooftop deck system of claim 1, without the seating.

7. The rooftop deck system of claim 1, without a combination of one or more of the following . . . the powered drive linkage, without locating the actuator system below the rooftop, without the safety handrails, or without the rooftop affixed seating.

8. The rooftop deck system of claim 1, wherein the vehicle is a recreational vehicle (motorcoach, motorhome, trailer, camper, van, caravan, sport utility vehicle, and the like).

9. The rooftop deck system of claim 1, wherein the vehicle is amphibious.

10. The rooftop deck system of claim 1, wherein the vehicle is a water craft (houseboat, boat, and the like).

11. A vehicle rooftop deck system comprising:
a raising and lowering roof-cover atop a vehicle exterior rooftop deck;
a plurality of rooftop affixed safety handrails which raise and lower under said roof-cover;
a plurality of rooftop affixed seating which raise and lower under said roof-cover;
and a powered actuator to raise and lower the safety handrails.

12. The rooftop deck system of claim 11, without the raising and lowering roof-cover.

13. The rooftop deck system of claim 11, without a combination of one or more of the following . . . the roof-cover, handrails, the seating, the powered actuator.

14. The rooftop deck system of claim 11, wherein the vehicle is a recreational vehicle (motorcoach, motorhome, trailer, camper, van, caravan, sport utility vehicle, and the like).

15. The rooftop deck system of claim 11, wherein the vehicle is amphibious.

16. The rooftop deck system of claim 11, wherein the vehicle is a water craft (houseboat, boat, and the like).

17. A vehicle rooftop deck system comprising:
a plurality of rooftop affixed seating which raise and lower;
a plurality of rooftop affixed safety handrails which raise and lower;
and a roof-cover atop the said seating and handrails which raises for occupancy of the rooftop deck and lowers for travel.

18. The rooftop deck system of claim 17, without the roof-cover.

19. The rooftop deck system of claim 17, where the seating backs incorporate the handrails.

20. The rooftop deck system of claim 17, wherein the vehicle is a recreational vehicle (motorcoach, motorhome, trailer, camper, van, caravan, sport utility vehicle, and the like).

21. The rooftop deck system of claim 17, wherein the vehicle is amphibious.

22. The rooftop deck system of claim 17, wherein the vehicle is a water craft (houseboat, boat, and the like).
